(19) United States
(12) Patent Application Publication
(10) Pub. No.: US 2012/0266846 A1
(43) Pub. Date: Oct. 25, 2012

(54) Dual fuel diesel engine system

(76) Inventor: Michael Kilbourne, Caledonia, WI (US)

(21) Appl. No.: 13/066,768

(22) Filed: Apr. 25, 2011

(51) Int. Cl. F02M 51/00

(52) U.S. Cl. 123/478

(57) ABSTRACT

A dual fuel system and method for an engine including a liquid fuel supply subsystem for supplying liquid fuel to the engine and an electronic control module configured to control, via one or more liquid fuel control signals, the amount of liquid fuel supplied to the engine based on one or more sensor signals. A gaseous fuel supply subsystem is configured to supply gaseous fuel to the engine and an electronic controller subsystem responsive to liquid fuel control signal(s) is configured to determine, based on the liquid fuel control signals, a modified amount of liquid fuel and an amount of gaseous fuel to be supplied to the engine for dual fuel operation.

### FIELD OF THE INVENTION

The subject invention relates to dual fuel systems for engines.

### BACKGROUND OF THE INVENTION

Dual fuel engines are known. See, for example, U.S. Pat. Nos. 6,901,889; 7,270,089; U.S. Patent Publication No. 2010/0332106; and WO 2007/115594 all incorporated herein by this reference.

Typical examples include a diesel engine operating on both diesel fuel and natural gas (e.g., CNG or LNG). The diesel fuel is usually delivered to a common rail and electronically controlled injectors or to unit injectors from a tank via pump(s) and valve(s) or via other components of a liquid fuel supply subsystem. The diesel fuel amount is controlled, in an unmodified engine, at least in part by the vehicle's electronic control module (ECM) based on a variety of sensor signals (accelerator pedal position, engine speed and position, exhaust gas characteristics, and the like).

Natural gas is supplied via high pressure direct injection into the intake manifold or otherwise into the engine. The amount of natural gas supplied is also electronically controllable via a metering device, gaseous fuel injector, or the like.

At some point, the amount of natural gas is adjusted and the amount of diesel fuel is adjusted so only a very small amount of the diesel fuel is supplied to the engine in order to ignite the natural gas. In this “pilot ignited gaseous fuel mode”, the engine is fueled primarily by natural gas.

Thus, the amount of diesel fuel must be controllable by an after market dual fuel system. In one design, a controller is added which coordinates with the vehicle ECM to control the supply of diesel fuel supplied to the engine (typically via the injectors). See WO 2007/115594. Such systems can void the manufacturer's warranty and also suffer from several additional limitations.

In WO 2007/115594, a system is proposed that intercepts and interprets the sensor signals input into the ECM. Those sensor signals are then modified so the ECM provides a predetermined amount of diesel fuel to the engine in order to run in the pilot fuel supply mode. As stated in WO 2007/115594, sensor data signals supplied to the ECM and used by it to control operation of the diesel fuel injectors are intercepted and modified before being transmitted to the ECM. The ECM is, in essence, “tricked” into controlling the diesel fuel injectors to effect the pilot fuel supply mode during dual fuel operation.

### BRIEF SUMMARY OF THE INVENTION

Such a system can be highly complex. The gaseous fuel controller which intercepts and interprets the original equipment manufacturer's (OEM) ECM sensor signals has to be connected to numerous sensors such as the accelerator pedal position sensor, the engine position sensor, the intake manifold pressure sensor, the intake manifold temperature sensor, and other sensors such as a coolant temperature sensor, an ambient pressure sensor, an ambient temperature sensor, and a vehicle speed sensor in order to control both the amount of diesel fuel and natural gas supplied to the engine. Mapping or calculating the optimal ratio of diesel fuel and natural gas based on these sensor signals can be difficult. In general, the amount of fuel supplied to the engine in an unmodified engine based on the output of the sensors is deemed proprietary by the OEM. Complex algorithms are required to meter the appropriate amount of natural gas and diesel fuel under different operating conditions. See U.S. Pat. Nos. 6,598,584 and 7,270,089 incorporated herein by this reference.

Furthermore, intercepting and interpreting sensor signals and/or “tricking” an OEM ECM may be deemed by the OEM and/or government agencies (for example, the E.P.A) as problematic and/or undesirable.

The subject invention features a system which does not need to be connected to any of the vehicle sensors and which does not require complex algorithms which attempt to make sense of the sensor signals. A dual fuel system in accordance with the subject invention, in one preferred embodiment, is able to operate on 80% natural gas with no or little power loss on hills or during acceleration. The system is quickly installed and fairly inexpensive. The system does not void the engine warranty and requires no mechanical or electrical modifications to the original diesel engine or emission system.

In a preferred embodiment, instead of intercepting and attempting to interpret vehicle sensor signals, an electronic controller device is configured to intercept the actual diesel fuel control signals output by the ECM and then modifies those signals based on a desired ratio of natural gas to diesel fuel.

The invention features, in one version, a compression internal combustion system comprising an engine including one or more cylinders, a liquid fuel supply subsystem for supplying liquid fuel to the engine, and an electronic control module configured to control, via one or more liquid fuel control signals, the amount of liquid fuel supplied to the engine based on one or more sensor signals. For dual fuel operation, a gaseous fuel supply subsystem is added and configured to supply gaseous fuel to the engine. An electronic controller subsystem is responsive to one or more of the liquid fuel control signals and is configured to determine, based on the liquid fuel control signals, the amount of liquid fuel and gaseous fuel to be supplied to the engine for dual fuel operation. The liquid fuel supply subsystem is controlled to supply the determined amount of liquid fuel to the engine and the gaseous fuel supply subsystem is controlled to supply the determined amount of gaseous fuel to the engine.

In one example, the liquid fuel supply subsystem includes electronically controlled liquid fuel injectors and the electronic controller subsystem is wired to one or more voltage lines between the electronic control module and the liquid fuel injectors. The electronic controller subsystem then controls the liquid fuel supply subsystem by delivering modified voltages on one or more the voltages line to control one or more the liquid fuel injectors.

In some embodiments, the gaseous fuel supply subsystem includes electronically controllable gaseous fuel injectors each opened and closed via signals from the electronic controller subsystem. Also, the electronic controller subsystem can be responsive to the vehicle sensor bus and configured to take a predetermined action if a fault condition is transmitted on the sensor bus. One predetermined action includes stopping the supply of gaseous fuel in response to a fault condition.

Preferably, the electronic controller subsystem controls the liquid fuel supply subsystem by delivering one or more modified liquid fuel control signals to the liquid fuel supply subsystem and the modified liquid fuel control signals are a predetermined percentage of the liquid fuel control signals output by the electronic control module to present a percentage X of liquid fuel to the engine. The electronic controller subsystem typically controls the gaseous fuel supply subsystem to supply 100-X % gaseous fuel to the engine.

The system may further include a display and the electronic controller subsystem is then configured to show, on the display, the determined amount of liquid fuel and the determined amount of gaseous fuel.

A compression internal combustion system in accordance with aspects of the invention features an engine, a liquid fuel supply subsystem for supplying liquid fuel to the engine, and an electronic control module configured to control, via one or more liquid fuel control signals, the amount of liquid fuel supplied to the engine based on one or more sensor signals. A gaseous fuel supply subsystem is configured to supply gaseous fuel to the engine, and an electronic controller subsystem is responsive to one or more of the liquid fuel control signals and configured to determine, based on the liquid fuel control signals, a modified amount of liquid fuel and an amount of gaseous fuel to be supplied to the engine for dual fuel operation. One or more modified liquid fuel control signals are delivered to the liquid fuel supply subsystem to control the liquid fuel supply subsystem and to supply the determined modified amount of liquid fuel to the engine. The gaseous fuel supply subsystem is controlled to supply the determined amount of gaseous fuel to the engine.

A dual fuel method in accordance with aspects of the invention features supplying liquid fuel to an engine via a liquid fuel supply subsystem, controlling, via one or more liquid control signals, the amount of liquid fuel supplied to the engine based on one or more sensor signals. A gaseous fuel supply subsystem is connected to the engine for dual fuel operation. One or more liquid fuel control signals are intercepted and the method includes determining, based on one or more intercepted liquid fuel control signals, a modified amount of liquid fuel and also an amount of gaseous fuel to be supplied to the engine in a dual fuel mode. The liquid fuel supply subsystem is controlled to supply the determined modified amount of liquid fuel to the engine and the gaseous fuel supply subsystem is controlled to supply the determined amount of gaseous fuel to the engine.

A dual fuel engine control system in accordance with the invention may feature a controllable gaseous fuel supply subsystem configured to supply gaseous fuel to an engine, and an electronic controller subsystem which is configured to intercept one or more liquid fuel control signals, to determine based on one or more of the intercepted liquid fuel control signals, a modified amount of liquid fuel and an amount of gaseous fuel to be supplied to the engine, to control the gaseous fuel supply subsystem to supply the determined amount of gaseous fuel to the engine, and to control liquid fuel supply subsystem to supply the determined modified amount of liquid fuel to the engine.

A dual fuel control method includes supplying gaseous fuel to an engine, intercepting one or more liquid fuel control signals, and determining, based on one or more intercepted liquid fuel control signals, an amount of liquid fuel and gaseous fuel to be supplied to the engine. The determined amount of gaseous fuel is supplied to the engine, and the determined amount of liquid fuel is supplied to the engine.

The invention further features a method of operating a compression ignition internal combustion engine having an electronic control module configured to control, via one or more control signals, the amount of liquid fuel delivered to the engine based on one or more sensor signals. One method includes intercepting one or more of the control signals, supplying the intercepted control signals to an electronic controller subsystem, and using the electronic controller subsystem to determine an amount of liquid fuel and an amount of gaseous fuel to be supplied to the engine based on the intercepted control signals.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic block diagram showing the primary components associated with a dual fuel system in accordance with one example of the invention;

FIG. 2 is a flow chart depicting the primary steps associated with the programming of the electronic control unit controller of FIG. 1 in order to remap the OEM fuel curve for dual fuel operations; and

FIG. 3 is a flow chart depicting the primary steps associated with the programming of the electronic control unit controller of FIG. 1 for operation of the engine in a dual fuel mode.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

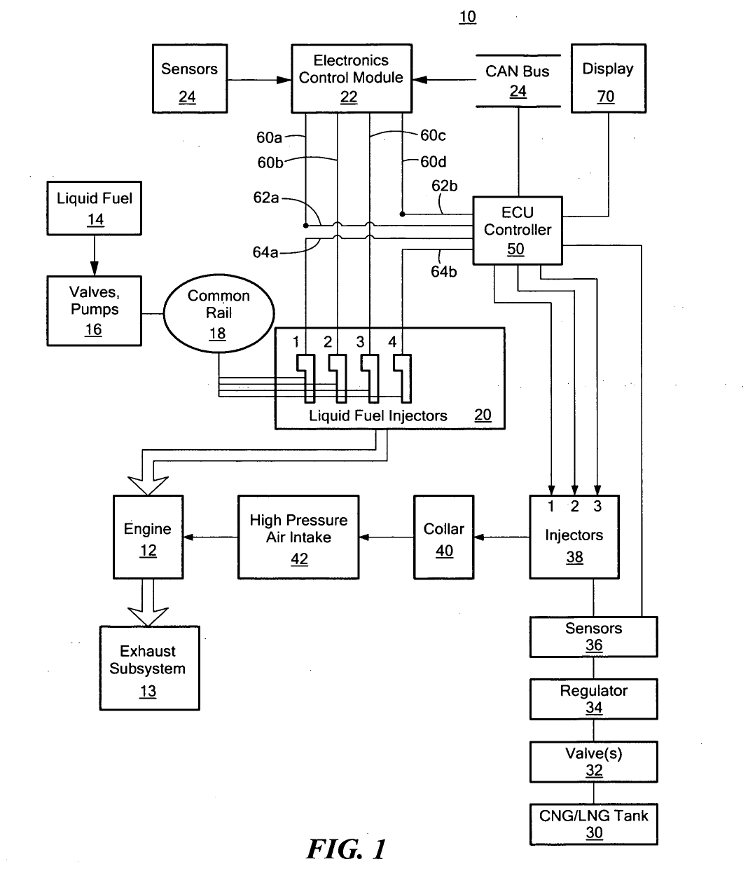

FIG. 1 depicts an example of a dual fuel system 10 for engine 12, typically a diesel engine or “compression internal combustion engine”. In some embodiments, there are a plurality of cylinders, with a piston in each cylinder defining a combustion chamber between a cylinder head and the piston. The piston is connected to a crank shaft in a conventional manner. Inlet and exhaust valves are provided and may be actuated by a cam shaft rotated by the crank shaft to control the supply of air/fuel mixture to and the exhaust of combustion products from the combustion chamber via exhaust subsystem 13. Gases may be supplied to and exhausted from engine 10 via an air intake manifold and an exhaust manifold. A turbo charger may be included as well.

In this example, there is a fuel supply subsystem whereby liquid fuel, e.g. diesel fuel, is presented to engine 12 from tank 14 via valves, pumps and the like represented at 16, in this example, to common rail supply 18 and injectors 20. In other embodiments, diesel fuel is supplied via unit injectors or a pump/nozzle supply system having multiple electronically controllable liquid fuel injectors. Various filters, pumps, high pressure release valves, pressure regulators and the like are also typically employed.

The amount of diesel fuel supplied to the engine cylinders is controlled by OEM ECM 22 based on the output of sensors 24. The sensor data may include an accelerator pedal position sensor, an engine position sensor, an intake manifold pressure sensor, an intake manifold temperature sensor, a coolant temperature sensor, an ambient pressure sensor, an ambient temperature sensor, a vehicle speed sensor, and the like. Sensor signals are typically transmitted on can bus 24.

In one preferred embodiment, a second gaseous fuel source is added, e.g., CNG or LNG tank 30. The natural gas supply subsystem includes, in this particular design, various valves 32, a regulator 34 (controlling the pressure of the natural gas to 120 psi, for example), sensors 36 (typically for sensing temperature and pressure), and a controllable natural gas metering device such as injector subsystem 38. Other metering devices, gaseous fuel injectors, and the like may be used. In this particular example, natural gas then proceeds via collar 40 into high pressure air intake 42 of engine 12. In other designs, a separate electronically actuated external injector can be provided for each cylinder or, in the case of a shared port intake system, for each pair of injectors or from a single point source for the entire engine. Natural gas can also be supplied to the air intake manifold as is known.

Electronic control unit controller 50 electronically controls the amount of natural gas supplied to the engine by opening and closing different combinations of injectors. In the example shown, there are three injectors.

Electronic control unit controller 50 functions to control the relative amounts of diesel fuel and natural gas presented to engine 12. As depicted, OEM ECM 22 outputs one or more diesel fuel control signals as shown in this example via different voltages on lines 60a, 60b, 60c, and 60d to injectors 1, 2, 3 and 4 of the liquid fuel injector subsystem 20. As explained above, the voltage supplied on each line 60a-60d is a function of the sensor signals transmitted to ECM 22 and the map or fuel curve programmed into ECM 22. Such maps are relatively complex and are typically proprietary.

In aspects of the invention, electronic control unit controller 50 is responsive to one or more of the diesel fuel control signals output by ECM 22 as shown by line 62a connected to line 60a and line 62b connected to line 60d. Thus, one or more of the diesel fuel control signals output by ECM 22 are read by electronic control unit controller 50. Based on the voltage levels read on lines 60a and 60b, electronic control unit controller 50 determines the amount of diesel fuel and natural gas to be supplied to engine 12. Electronic control unit controller 50 controls, at least partially, the diesel fuel injectors as shown by voltage lines 64a and 64b supplying voltages to injectors 1 and 4 which results in the desired amount of diesel fuel injected into the engine by liquid fuel injector subsystem 20 for dual fuel operation. Electronic control unit controller 50 also controls injectors 1 through 3 of the natural gas fuel supply subsystem as shown to meter the desired amount of natural gas into the engine for dual fuel operation.

As shown in Table 1, below, V_{ECM} is the voltage output by ECM 22 on lines 60a-60d for diesel fuel only operation. In this particular example, V_{ECM} is the same on lines 60a, 60b, 60c, and 60d. V_{ECU}, a modified voltage, is output by ECU controller 50 on lines 64a and 64b. In this particular example, V_{ECU} is the same on both lines 64a and 64b and controlling the diesel fuel flow to only two injectors is sufficient for dual fuel operations. In other examples, more, less, or all of the injectors may be controlled by controller 50.

TABLE 1

| V_{ECM} | V_{ECU} | Gaseous Fuel Injectors | Condition |
|---|---|---|---|
| Low | — | 1, 2, 3 closed | Idle |
| 60% max | 40% max | 1 open | Cruise Flat |
| 70% max | 30% max | 1, 2 open | Cruise |
| | | | Slight grade |
| Max | 20% max | 1, 2, 3 open | Steep grade |
| V_{ECM} | — | 1, 2, 3 closed | Fault condition |
| V_{ECM} | — | 1, 2, 3 closed | Gaseous fuel N/A |

When the voltage output by ECM 22 is low, the engine is idling and no natural gas is injected. Electronic control unit controller 50 presents an unmodified voltage V_{ECM} on line 64a and 64b and controls injector block 38 to close all three injectors in such an idling condition.

In one particular example, when V_{ECM} output by ECM 22 is at the maximum voltage (e.g., when the vehicle is driven up a steep uphill grade), electronic control unit controller 50 presents voltages on lines 64a and 64b that result in a signal of 20% of the maximum V_{ECM} voltage signal resulting in 20% of the maximum diesel fuel amount supplied to engine 12 and 80% natural gas supplied when electronic control unit controller 50 opens injectors 1, 2, and 3 of injector block 38. In the transition to this pilot fuel supply mode, the decrease in diesel fuel supplied and the increase in the amount of natural gas supplied is preferably accomplished in a stepwise fashion for a smoother operation and typically occurs within one to two seconds.

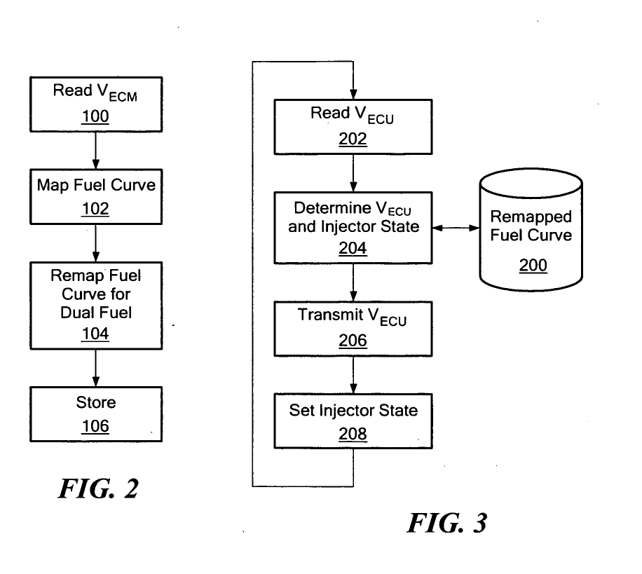

Table 1 also shows other natural gas and diesel fuel mixture possibilities. Typically, this remap of the fuel curve is accomplished by reading V_{ECM} output by OEM ECM 22, FIG. 1, step 100, FIG. 2 during various operating conditions without injecting any natural gas. The OEM fuel curve is then mapped, step 102. For dual fuel operations, the fuel curve is then remapped, step 104 (Table 1 is only a partial remap) and stored in memory or the like. Electronic control unit controller 50 may be a microprocessor, microcontroller, or the like. Typically, the remap will be different for different vehicles, and even as between the same engine but different versions of the same engine.

FIG. 3 shows the remapped fuel curve stored in database 200. As discussed above, during operation, one or more of the diesel fuel control signal or signals output by the OEM ECM are read at step 202. Based on the amount of diesel fuel being delivered to the engine, a desired ratio of natural gas to diesel fuel is calculated or looked up and the appropriate modified diesel fuel control signal is determined and the natural gas injector state is set, step 204. Then, the modified diesel fuel control signal(s) are transmitted to the diesel fuel supply subsystem, step 206, and the natural gas injector state is transmitted to the natural gas supply subsystem, step 208.

Table 1 depicts two additional conditions wherein all three natural gas injectors are closed and the voltages output by the OEM ECM are not modified. As shown in FIG. 1, electronic control unit controller 50 can be tapped into vehicle can bus 24 to read any fault signals transmitted over can bus 24. If a fault signals is detected, for example, an alternator fault condition, all three natural gas injectors of block 38 are closed and the diesel fuel control signals output by the electronic control module are not modified. The same condition is true if no natural gas is available, as for example, determined by sensors 36, FIG. 1.

FIG. 1 also shows a display which can be mounted in the cabin of the vehicle to display, among other things, the ratio of diesel fuel to natural gas, the amount of natural gas remaining in the natural gas tank or tanks, and the like. Display 70 can be wired to electronic control unit controller 50 or wireless communications between electronic control unit controller 50 and display 70 can be used.

The result is a system for and method of operating a compression ignition internal combustion engine typically having an electronic control module configured to control, via one or more control signals, the amount of liquid fuel delivered to the engine based on one or more sensor signals. The liquid fuel control signals are intercepted and are provided to an after market electronic controller which determines the amount of liquid fuel and gaseous fuel to be supplied to the engine based on the intercepted liquid fuel control signals. Then, modified liquid control signals are supplied to the liquid fuel supply subsystem to change the amount of liquid fuel delivered to the engine and to supply the determined amount of gaseous fuel to the engine.

Although specific features of the invention are shown in some drawings and not in others, however, this is for convenience only as each feature may be combined with any or all of the other features in accordance with the invention. Also, the words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A compression internal combustion system comprising:
an engine including one or more cylinders;
a liquid fuel supply subsystem for supplying liquid fuel to the engine;
an electronic control module configured to control, via one or more liquid fuel control signals, the amount of liquid fuel supplied to the engine by the liquid fuel supply subsystem based on one or more sensor signals;
a gaseous fuel supply subsystem configured to supply gaseous fuel to the engine; and
an electronic controller subsystem responsive to one or more said liquid fuel control signals and configured to:
determine, based on said one or more liquid fuel control signals, the amount of liquid fuel and gaseous fuel to be supplied to the engine for dual fuel operation,
control the liquid fuel supply subsystem to supply said determined amount of liquid fuel to the engine, and
control the gaseous fuel supply subsystem to supply said determined about of gaseous fuel to the engine.

2. The system of claim 1 in which the liquid fuel supply subsystem includes electronically controlled liquid fuel injectors.

3. The system of claim 2 in which the electronic controller subsystem is wired to one or more voltage lines between the electronic control module and the liquid fuel injectors.

4. The system of claim 3 in which the electronic controller subsystem controls the liquid fuel supply subsystem by delivering modified voltages on one or more said voltage lines to control one or more said liquid fuel injectors.

5. The system of claim 1 in which the gaseous fuel supply subsystem includes electronically controllable gaseous fuel injectors each opened and closed via signals from the electronic controller subsystem.

6. The system of claim 1 further including a sensor bus and the electronic controller subsystem is responsive to the sensor bus and configured to take a predetermined action if a fault condition is transmitted on the sensor bus.

7. The system of claim 6 in which one predetermined action includes stopping the supply of gaseous fuel in response to a fault condition.

8. The system of claim 1 in which the electronic controller subsystem controls the liquid fuel supply subsystem by delivering one or more modified liquid fuel control signals to the liquid fuel supply subsystem.

9. The system of claim 8 in which the modified liquid fuel control signals are a predetermined percentage of the liquid fuel control signals output by the electronic control module to present a percentage X of liquid fuel to the engine.

10. The system of claim 9 in which the electronic controller subsystem controls the gaseous fuel supply subsystem to supply 100-X % gaseous fuel to the engine.

11. The system of claim 1 further including a display and the electronic controller subsystem is configured to show, on the display, the determined amount of liquid fuel and the determined amount of gaseous fuel.

12. A compression internal combustion system comprising:
an engine;
a liquid fuel supply subsystem for supplying liquid fuel to the engine;
an electronic control module configured to control, via one or more liquid fuel control signals, the amount of liquid fuel supplied to the engine by the liquid fuel supply subsystem based on one or more sensor signals;
a gaseous fuel supply subsystem configured to supply gaseous fuel to the engine; and
an electronic controller subsystem responsive to one or more said liquid fuel control signals and configured to:
determined, based on said one or more liquid fuel control signals, a modified amount of liquid fuel and an amount of gaseous fuel to be supplied to the engine,
deliver one or more modified liquid fuel control signals to the liquid fuel supply subsystem to control the liquid fuel supply subsystem to supply said determined modified amount of liquid fuel to the engine, and
control the gaseous fuel supply subsystem to supply the determined amount of gaseous fuel to the engine.

13. A dual fuel method comprising:
supplying liquid fuel to an engine via a liquid fuel supply subsystem;
generating one or more liquid fuel control signals to vary the amount of liquid fuel supplied to the engine by the liquid fuel supply subsystem based on one or more sensor signals;
intercepting one or more of said liquid fuel control signals;
connecting a gaseous fuel supply subsystem to the engine for operation in a dual fuel mode;
determining, based on one or more said intercepted liquid fuel control signals, a modified amount of liquid fuel and an amount of gaseous fuel to be supplied to the engine in a dual fuel mode;
controlling the liquid fuel supply subsystem to supply said determined modified amount of liquid fuel to the engine; and
controlling the gaseous fuel supply subsystem to supply said determined amount of gaseous fuel to the engine.

14. The method of claim 13 in which the liquid fuel supply subsystem includes electronically controlled liquid fuel injectors.

15. The method of claim 14 including wiring an electronic controller subsystem to one or more voltage lines connected to the liquid fuel injectors.

16. The method of claim 15 in which controlling the liquid fuel supply subsystem includes delivering modified voltages on one or more said voltage lines to control the injectors.

17. The method of claim 13 in which the gaseous fuel supply subsystem includes electronically controllable gaseous fuel injectors and controlling the gaseous fuel supply includes controlling said gaseous fuel injectors.

18. The method of claim 13 further detecting fault conditions and taking a predetermined action if a fault condition is detected.

19. The method of claim 18 in which one predetermined action includes stopping the supply of gaseous fuel in response to a fault condition.

20. The method of claim 13 further including displaying the determined amount of liquid fuel and the determined amount of gaseous fuel.

21. A dual fuel engine control system comprising:
a controllable gaseous fuel supply subsystem configured to supply gaseous fuel to an engine; and
an electronic controller subsystem configured to:
intercept one or more liquid fuel control signals;
determine based on one or more of said intercepted liquid fuel control signals, a modified amount of liquid fuel and an amount of gaseous fuel to be supplied to the engine,
control the gaseous fuel supply subsystem to supply said determined amount of gaseous fuel to the engine, and
control a liquid fuel supply subsystem to supply said determined modified amount of liquid fuel to the engine.

22. The system of claim 21 in which the electronic controller subsystem is wired to one or more voltage lines connected to liquid fuel injectors of the engine.

23. The system of claim 22 in which the electronic controller subsystem controls the liquid fuel supply subsystem by delivering modified voltages on one or more said voltage lines to control the injectors.

24. The system of claim 21 in which the electronic controller subsystem is responsive to an engine sensor bus and further configured to take a predetermined action if a fault condition is transmitted on the sensor bus.

25. The system of claim 24 in which one predetermined action includes stopping the supply of gaseous fuel in response to a fault condition.

26. A dual fuel control method comprising:
intercepting one or more liquid fuel control signals;
determining, based on one or more intercepted liquid fuel control signals, an amount of liquid fuel and gaseous fuel to be supplied to the engine;
supplying said determined amount of gaseous fuel to the engine; and
supplying said determined amount of liquid fuel to the engine.

27. A method of operating a compression ignition internal combustion engine having an electronic control module configured to control, via one or more control signals, the amount of liquid fuel delivered to the engine based on one or more sensor signals, the method comprising:
intercepting one or more said liquid fuel control signals;
supplying said intercepted control signals to an electronic controller subsystem;
using the electronic controller subsystem to determine a modified amount of liquid fuel and an amount of gaseous fuel to be supplied to the engine based on the intercepted control signals for dual fuel operation;
supplying one or more modified control signals to change the amount of liquid fuel delivered to the engine to said determined modified amount; and
supplying said determined modified amount of liquid fuel to the engine.

28. The method of claim 27 further including the step of supplying said determined amount of gaseous fuel to the engine.
